(19) United States
(12) Patent Application Publication
(10) Pub. No.: US 2011/0264994 A1
(43) Pub. Date: Oct. 27, 2011

(54) METHOD OF RETRIEVING INTERACTIVE ELECTRONIC DATA AND ACCESSING PRODUCTIVITY TOOLS FOR REAL PROPERTY VALUATION AND MORTGAGE UNDERWRITING SOFTWARE SYSTEMS

(75) Inventor: Michael S. Tarabotto, Porter Ranch, CA (US)

(73) Assignee: ForenSight, Inc., West Hills, CA (US)

(21) Appl. No.: 13/086,046

(22) Filed: Apr. 13, 2011

Related U.S. Application Data
(60) Provisional application No. 61/323,817, filed on Apr. 13, 2010.

(51) Int. Cl. G06F 17/00

(52) U.S. Cl. 715/226

(57) ABSTRACT

A real property appraisal system comprising at least one uniform appraisal form having embedded intelligence for automatically obtaining relevant information needed to complete the form.

### CROSS-REFERENCE TO RELATED APPLICATIONS

This application claims priority of U.S. Application Ser. No. 61/323,817, filed on Apr. 13, 2010, titled METHOD OF RETRIEVING INTERACTIVE ELECTRONIC DATA AND ACCESSING PRODUCTIVITY TOOLS FOR REAL PROPERTY VALUATION AND MORTGAGE UNDERWRITING SOFTWARE SYSTEMS, which application is incorporated by reference in this application in its entirety.

### BACKGROUND

1. Field of the Invention

The present invention relates to an embedded software tool that is embedded within certain forms fields within a form and that is capable of accessing further relevant software tools and software applications for processing and analyzing data entered into the form.

2. Background

The present invention relates to the field of real property appraisal and collateral valuation, mortgage underwriting and risk management; in particular, technology enabling a multi-purpose “node” embedded in, and accessible throughout, the relevant software that provides: (a) an efficient means of electronically retrieving static and dynamic digital data within a collateral valuation development and reporting system(s), collateral underwriting and mortgage decisioning system(s), risk management and reporting system(s), wherein said internal or external data resources are integrated and stored through a plurality of means to said systems, enabling the rapid transformation of said internal and external data into deployable, field level (or “context specific”) user intelligence; and (b) an efficient means of rapidly deploying workflow decisioning tools and productivity functions—said tools and functions being specific to certain input field of a certain form, or plurality of forms, or header sections of a larger reporting system wherein users of said system interact and write or complete work—by graphical user interface, or other electronic means of communication with the deployment tool.

### BRIEF DESCRIPTION OF THE DRAWINGS

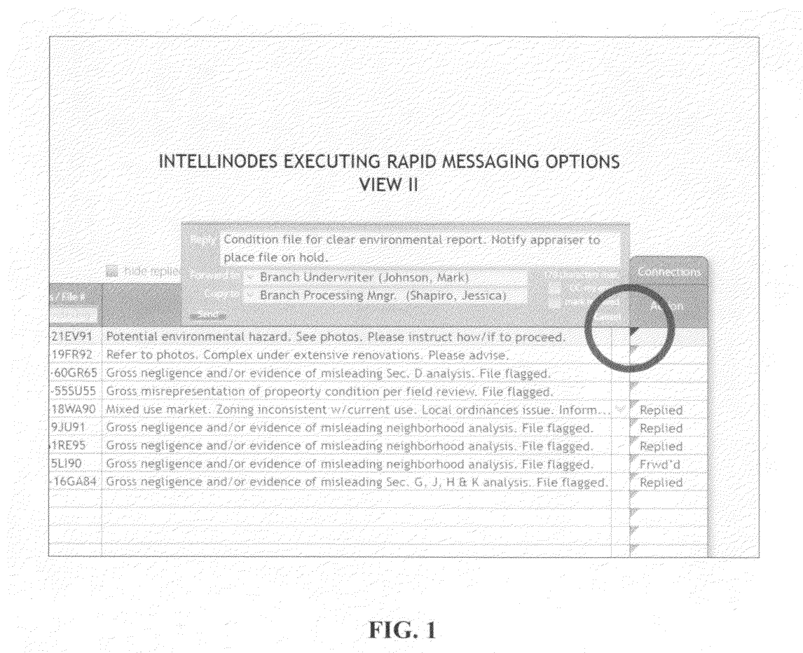

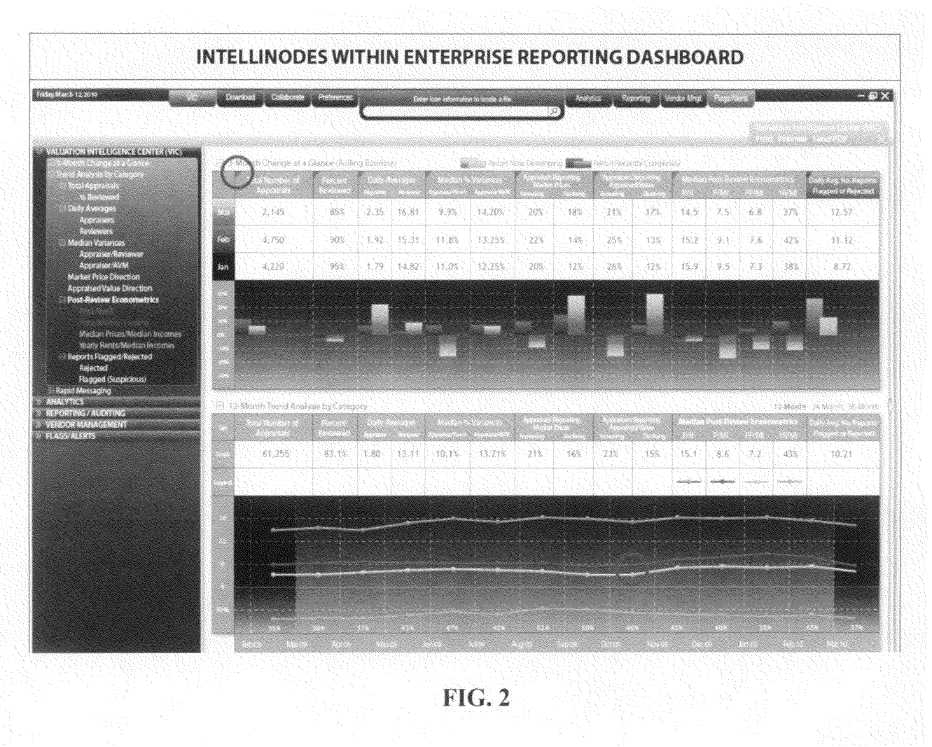

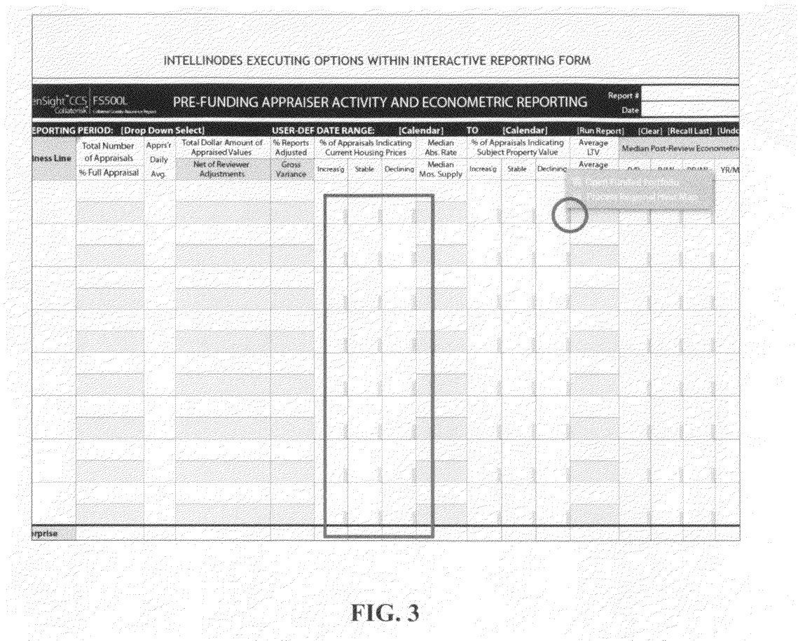

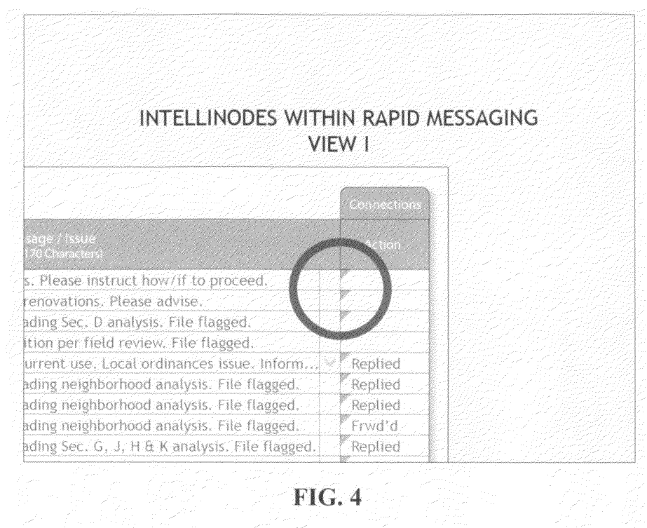

Examples of how the intellinode may be illustrated in the forms are attached as FIGS. 1-4. Not every intellinode implementation can be easily illustrated in this submission. This paper focuses on the three basic implementations that illustrate use of the node within the body of an appraisal form, a related business intelligence “dashboard”, and a sample upstream reporting form; all of which could be part of a larger enterprise reporting library wherein the intellinode interlinks all three elements.

It will be understood and appreciated by persons skilled in the art that alternative implementations and embodiments facilitating the more efficient development and reporting of traditional valuation services and products (i.e., residential, commercial and industrial appraisals, desktop valuations, exterior-only appraisals, restricted-use appraisals, full-narrative appraisals, etc.) and delivery of mortgage origination services (i.e., residential, commercial and industrial loan applications, mortgage underwriting forms, consumer and corporate disclosure forms, etc.) will exist and evolve; and that the invention extends its scope to so-called “non-traditional” real property valuation products, services and software relating to, but not limited to: automated valuation modeling and collateral-risk assessment technologies; valuation lifecycle management and appraisal process management technologies; loan origination software (LOS) and related loan-fulfillment technologies; and business intelligence reporting technologies more generally.

### DETAILED DESCRIPTION

The contemplated invention—which can be characterized as an “intelligence node”, and that will be referred to from time-to-time heretofore as an “intellinode”—provides those skilled in the art of real property appraisal and collateral valuation, credit underwriting and risk assessment with a universally recognizable “icon” embedded throughout their assignment development and reporting medium providing the relevant users with (a) ready-access to common workflow functions and tools (i.e., rapid messaging, field defaults, word processing options, etc.), and (b) field-relevant data analysis and drilldown capabilities for specific intelligence (i.e., executable programs displaying data analytics, photographic displays, aerial imagery, on-demand mapping, etc.).

The present invention could be easily embodied in a grey, vertically rectangular “node” occupying roughly the space of a standard alpha/numeric character of a common word processor, or form field; or any universality of embodiments depicting a small, easily recognizable and intuitively located and accessible information access-point embedded within, and readily accessible throughout, alpha-numeric text fields or header sections of an assignment development and reporting medium, or workspace—said workspace including, but not limited to: a real property appraisal report; alternative collateral valuation report or quality control/assurance system; risk assessment report; consumer loan application; consumer and corporate credit ratings report, or related industry reporting and communication media whereby information can be ultimately deliverable in both digital or analogue forms.

Market participants with regular experience with valuation and risk management services including government sponsored enterprises, housing agencies, private institutional investors and mortgage insurers as well as enterprises involved in the securitizing and rating of credit instrumentalities and derivative instruments where collateral is referenced, will particularly appreciate the invention's ability to drill deeply into collateral valuation reports and the optimization of interconnected workflow efficiencies that expedite due diligence and raise the confidence in underlying work product(s) and resulting potential investment liquidity gains.

Technologies currently in existence relating to the contemplated invention and field of use generally afford very basic, unintuitive functions often limited to saving and recalling “template” responses (i.e., comments, words, phrases, etc.) to a field. While this is handy, as users can quickly populate fields that otherwise require redundant manual entry; appraisers, for instance, more often require the ability to drilldown into property data to gain actionable intelligence, or productivity tools to more effectively complete tasks—not simply template responses.

The same has been said for mortgage origination software currently in use, wherein user's lack the ability to drilldown into borrower-specific information relevant to a field question; or easily link multiple parts of certain forms as the situation demands; or access productivity tools for communicating issues to relevant parties of a transaction in a seamless manner.

Commonly used Web-based applications such as interne email illustrate the type of basic functionality found in valuation and mortgage origination software in use today. For example, in situations where a user is required to enter a field value into a “context static” field—meaning the field question and its response are always the same (i.e., first name, telephone number, etc.)—a drop-down will provide the user the option to select from previously saved entries, and based upon the entry selected, the field automatically populates the entry. This is a standard feature found in most appraisal and origination software.

However, where field values are not “context static” but instead are “context dependant”, or “context dynamic”—meaning the appropriate response or value to be inserted depends on an analysis of other information wherein the verification processes can require multiple sources of data, or layers of information to accurately respond to the field question—existing software functionality is woefully inadequate and requires that—specifically the case with real estate appraisers—users divert their attention away from their immediate workspace to other sources of information (digital/analogue) to contemplate then complete the field accurately.

For professional appraisers this presents a significant productivity barrier as it disturbs the flow of analysis and inhibits the speed with which reports can be returned to their end users. And given the myriad resources appraisers must rely on to fully develop and accurately report an appraisal, this impediment raises the risk of errors since back and forth review of digital and analogue data can cause confusion.

Whereas common appraisal software today provides its users mainly the ability retrieve previously saved field values, or retrieve template commentary specific to a commentary field, or access mathematic computation tools for certain native-to-the-industry functions preset elsewhere; the intellinode, on the other hand, strategically places access to complex analytics, interactive mapping and imaging functions, messaging syndication functions, content splicing options, and plurality of other well advanced, on demand, field level, “context dependant” functionality directly into the field of question, providing the appraiser (and other users of comparable software and business complexity) with a variety of business functions specific to, and dependent upon, the context with which said intellinode is used.

Those skilled in the art of software design and, more specifically, appraisal development and reporting and loan origination software technologies, will appreciate the ability of the invention's wider use across related industry verticals wherein intelligent “nodes” could be placed throughout the body of a plurality of reporting forms, or libraries of forms, not limited to only appraisal forms, or complete sets of enterprise reporting libraries, but also on-demand analytic dashboards or similar graphical interfacing intelligence reporting mediums, such as medical reporting systems or similarly complex systems wherein the ability to drill down, aggregate, and/or syndicate information is particularly useful.

It will be understood, and is appreciated by persons skilled in the art, that one or more processes, sub-processes, or process steps described in connection with FIGS. 1-5 may be performed by hardware and/or software. If the process is performed by software, the software may reside in software memory (not shown) in a suitable electronic processing component or system such as, one or more of the functional components or modules schematically depicted in FIGS. 1-5. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

I claim:

1. A real property appraisal system comprising at least one uniform appraisal form having embedded intelligence for automatically obtaining relevant information needed to complete the form.

2. The system of claim 1 where the intelligence analyzes the obtained information to provide the information needed.

3. The system of claim 1 where the information obtained is historic and forecast information.

4. The system of claim 1 where the information obtained may be utilized to support forecast data.

5. The system of claim 1 where the form includes links to web-based appraisal management platforms and where the system is designed to automatically extract information from the web-based appraisal management platforms.

6. A real property appraisal system comprising at least one uniform appraisal form capable of storing data that is utilized to populate the form and associating the stored data with fields in the form for later retrieval.

7. A real property appraisal system comprising at least one uniform appraisal form that includes comments fields associated with various data fields on the form for storing preparing and reviewer comments about form data.
